(19) United States
(12) Patent Application Publication
(10) Pub. No.: US 2006/0202798 A1
(43) Pub. Date: Sep. 14, 2006

(54) Frequency hopping for passive start and entry systems

(75) Inventors: Josef Baumgartner, Voels (AT); Charles F. Muma, Swartz Creek, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/345,884

(22) Filed: Feb. 2, 2006

Related U.S. Application Data
(60) Provisional application No. 60/659,863, filed on Mar. 8, 2005.

(51) Int. Cl. G05B 19/00

(52) U.S. Cl. 340/5.61; 340/5.72; 340/825.72; 307/10.5; 340/5.62; 340/5.63; 340/426.36

(57) ABSTRACT

A passive start and entry system (PASE) monitors several RF frequencies to detect a fob signal and for noise at each of the several frequencies. When the PASE system detects noise on the default frequency another RF channel is selected for communication. A vehicle unit sends a signal to a fob indicating which frequency the fob should use to transmit. The fob resets an RF sender to the selected frequency. At the same time the vehicle unit resets the RF receiver to receive on that frequency.

The present invention claims the benefit of U.S. Provisional Patent Application No. 60/659,863, filed Mar. 8, 2005.

### BACKGROUND OF THE INVENTION

This invention relates to a passive start and entry system using multiple frequencies to transmit communications between the vehicle unit and a fob. More particularly, the vehicle unit switches frequencies to avoid noise that may interfere with communication between the vehicle unit and the fob.

Passive start and entry (PASE) systems perform the functions of unlocking and starting a vehicle without requiring a passenger to have a key. The PASE system vehicle unit communicates a signal to a fob that the passenger carries. The fob transmits a confirmation signal back to the vehicle unit and the vehicle doors are unlocked when the signal is confirmed. When an occupant leaves the vehicle the PASE system will relock the vehicle doors when the fob is a predetermined distance form the vehicle.

Currently PASE systems send an inquiry signal to the fob from a vehicle unit using a low frequency (LF) signal. The fob receives the LF communication and responds using a radio frequency (RF) signal. Disadvantageously, RF signals are vulnerable to noise that can interfere with the signal being received by the vehicle unit. This problem commonly occurs when the vehicle is in a location where other systems are using the same frequency band, such as near radio broadcast towers.

Accordingly, providing different frequency channels for the fob to vehicle communication would eliminate occurrences of signal interference.

It is therefore desirable to develop and design an improved communication system for passive start entry systems.

### SUMMARY OF THE INVENTION

An example passive start and entry system according to this invention uses multiple frequencies to transmit communications between the vehicle unit and a fob.

An example passive start and entry system (PASE) is located in a vehicle and includes a vehicle unit for controlling the PASE system. The PASE system is connected to the vehicle locks and the vehicle engine. The PASE system includes a fob that a passenger carries on their person.

The vehicle unit sends an inquiry using an LF signal from the vehicle to check for any fob within proximity to the vehicle. The fob sends an inquiry answer back to the vehicle unit receiver using an RF signal. When a confirming transmission is received the vehicle unit sends an unlock signal, a lock signal or a start engine signal as needed.

The vehicle unit monitors the default RF frequency to detect a fob and also monitors several alternative RF frequencies for noise. When the vehicle unit detects noise on the default frequency another RF channel is selected for communication. The vehicle unit LF transmitter sends a signal to the fob indicating which RF frequency the fob should use to transmit. The fob resets an RF sender to that frequency. At the same time the vehicle unit resets the RF receiver to receive on that frequency.

These and other features of the present invention can be best understood from the following specification and drawings, the following of which is a brief description.

### BRIEF DESCRIPTION OF THE DRAWINGS

FIG. 1 is a schematic illustration of a vehicle utilizing an example passive start and entry (PASE) system of the present invention.

FIG. 2 is flowchart illustrating the communication process of an example PASE system of the present invention.

FIG. 3 illustrates an example frequency selection process for the passive start and entry system of the present invention.

FIG. 4 illustrates another example frequency selection process for the passive start and entry system of the present invention.

### DETAILED DESCRIPTION OF THE PREFERRED EMBODIMENT

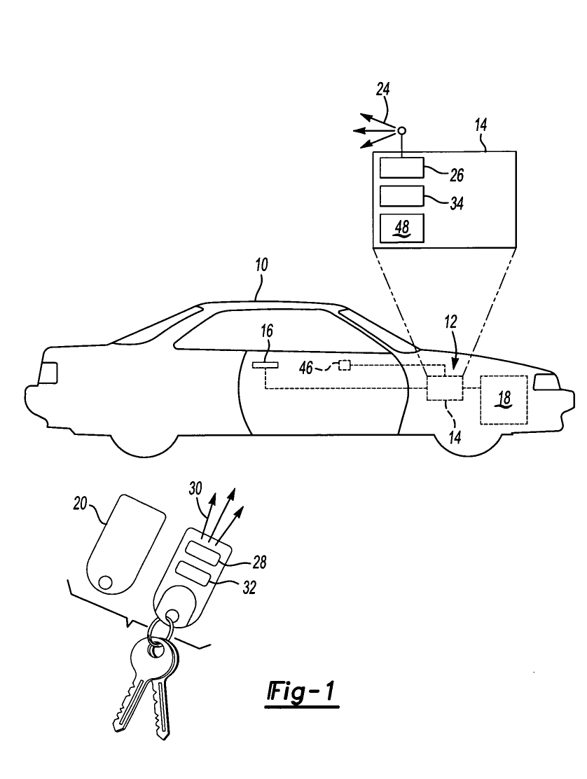

FIG. 1 illustrates a vehicle 10 having an example passive start and entry system (PASE) 12. The PASE system 12 includes a vehicle unit 14 for controlling the PASE system 12. The PASE system 12 is connected to the vehicle locks 16 and the vehicle engine 18. The vehicle engine 18 may be started by the PASE system 12 when the user actuates a start button 46. The PASE system 12 includes a fob 20. The fob 20 may be any device that a passenger may carry on their person and may be shaped like a traditional key fob, or as a card carried by a user. The fob 20 may have activation buttons. However, the fob 20 is typically passive requiring no activation by the user. The fob 20 includes a low frequency (LF) receiver 28 for receiving communications from the vehicle unit 14 and a radio frequency (RF) sender 32 for transmitting communications to a vehicle unit 14.

The vehicle unit 14 includes a LF sender 26 to send a LF signal to the fob 20 and the RF signal receiver 34 to receive a RF signal from the fob 20. The vehicle unit 14 also includes a received signal strength indicator (RSSI) 48. The RSSI 48 monitors the signal strength of several RF channels.

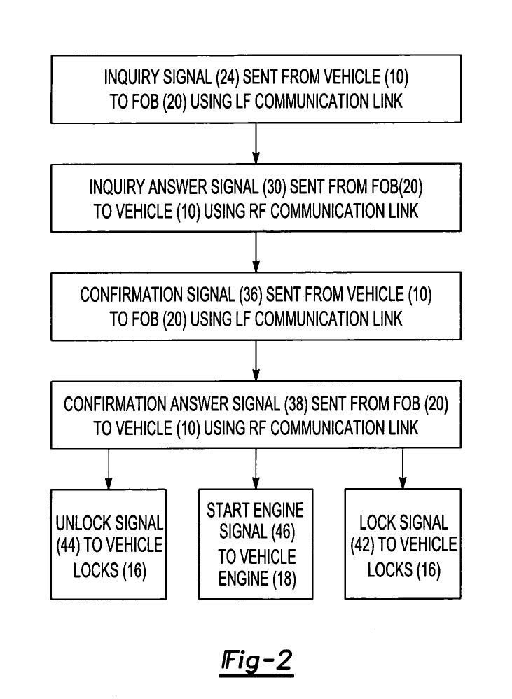

FIG. 2 illustrates the communication process of an example passive start and entry system 12 of the present invention. The vehicle unit 14 sends an inquiry signal 24 from the vehicle 10 to check for transmission from any fob 20 within proximity to the vehicle 10. The communications from the vehicle unit 14 to the fob 20 are sent using a LF signal. The vehicle unit 14 includes the LF sender 26 to send the LF signal. The transmission of the inquiry signal 24 may occur periodically or be initiated by the passenger, such as by touching a vehicle door handle.

The fob 20 has the LF receiver 28 to receive communications from the vehicle unit 14. The fob 20 sends an inquiry answer signal 30 back to the RF signal receiver 34. The communications from the fob 20 to the vehicle unit 14 are sent using an RF signal. The fob 20 includes the RF signal sender 32 and the vehicle unit 14 includes the RF signal receiver 34 to receive the RF signal.

Upon receipt of the inquiry answer signal 30 the vehicle unit 14 sends a confirmation signal 36 to the fob 20 using the LF channel. The fob 20 confirms it is the correct fob 20 for that vehicle 10 by sending a confirming answer signal 38 back to the RF signal receiver 34 using an RF channel. When a confirming answer signal 38 is received the vehicle unit 14 sends an unlock signal 40 to the vehicle locks 16. Similarly, the vehicle unit 14 can send a lock signal 42 to the vehicle locks 16 when the vehicle unit 14 determines that the fob 20 is no longer within a predetermined distance of the vehicle 10 or a start engine signal 44 when the user presses the start engine button 46.

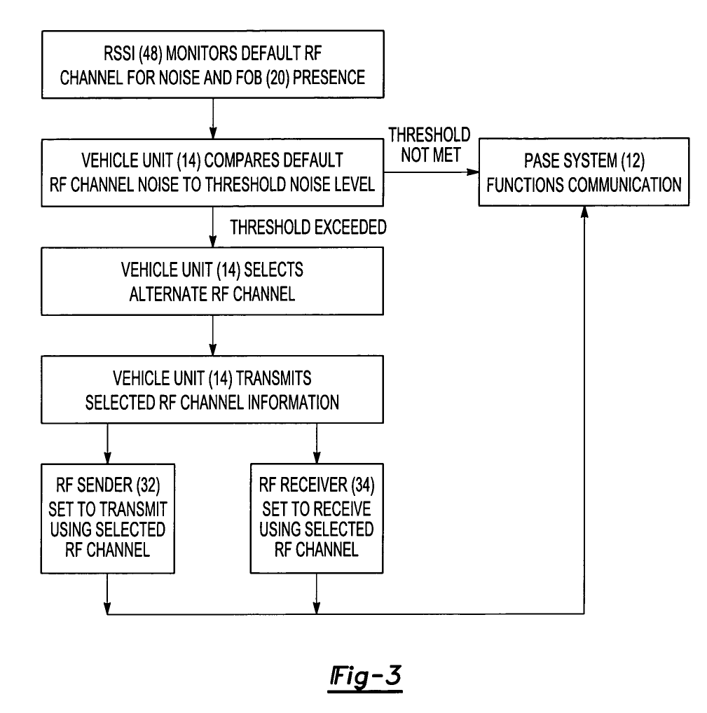

FIG. 3 illustrates an example frequency selection process for the PASE system 12. The vehicle unit 14 monitors several RF channels using the RSSI 48. In the example PASE system 12 the vehicle unit 14 monitors two RF channels. The vehicle unit 14 uses the receiver 34 to monitor the default RF channel to detect the presence of a fob 20. Simultaneously, the RSSI 48 monitors the two RF channels for noise. The vehicle unit 14 uses the information provided by the RSSI 48 to compare the noise level of the default RF channel to a predetermined noise threshold. When the noise is below the threshold level the PASE system 12 proceeds with the normal PASE system 12 communication. When the detected noise level on the default RF channel exceeds the predetermined noise threshold the vehicle unit 14 selects another RF channel for communication. In the example system, the second RF channel would be selected. If more than two RF channels are monitored the vehicle unit 14 would compare the signal strength of all the available RF channels to one another and select the channel with the lowest level of noise.

Upon selection of another RF channel for communication the vehicle unit 14 sends a signal to the fob 20 indicating which RF channel the fob 20 should use to transmit. The fob 20 resets the RF sender 32 to the selected frequency. At the same time the vehicle unit 14 resets the RF receiver 34 to receive on that frequency. The PASE system 12 then proceeds with the normal PASE system 12 functions communication.

The PASE system 12 can be configured to use the selected RF channel as the default channel for signal transmission until the RSSI 48 detects a threshold level of noise on the selected channel as described above. Alternately, the selected RF channel may be used to communicate temporarily, such as for one round of inquiry and confirmation between the fob 20 and the vehicle unit 14. The RF sender 32 and RF receiver 34 would then reset themselves to the pre-selected default channel.

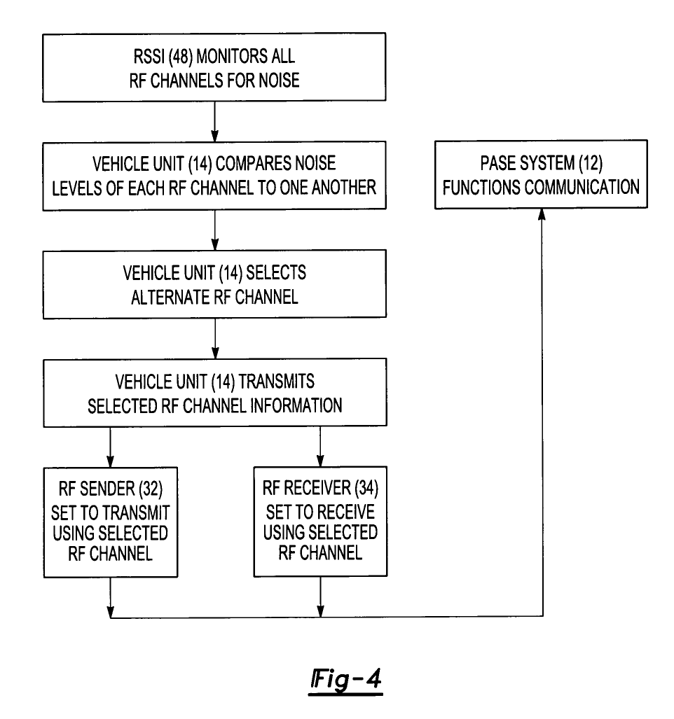

Referring to FIG. 4, the PASE system 12 may not have a default RF channel. The RSSI 48 monitors all available RF frequencies for noise. The vehicle unit 14 compares the noise levels for the frequencies and selects the frequency with the lowest noise level for communication. The selected channel is used for all communications until the fob 20 moves out of range of the vehicle 10 where the PASE system 12 would begin the monitor and selection process again.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A passive start and entry system comprising:
a vehicle unit for scanning a plurality of RF channels; and
a fob having an LF channel receiver to receive a communication from said vehicle unit and a RF channel sender to return a communication to said vehicle unit using one of said plurality of RF channels.

2. The system of claim 1, wherein said vehicle unit includes a signal strength indicator to scan said plurality of RF channels and determine a selected RF channel.

3. The system of claim 1, wherein said RF channel sender includes multiple RF channels.

4. The system of claim 2, wherein said selected RF channel is said channel having said least interference.

5. The system of claim 2, wherein said selected RF channel comprises said default channel.

6. The system of claim 1, wherein said vehicle unit includes an LF channel sender to send a communication to said fob and multiple RF channel receivers to receive a communication from said fob on one of said plurality of RF channels.

7. A method of communication for a vehicle passive entry and start system comprising:
a) scanning a plurality of RF channels using a vehicle receiver;
b) selecting one of the plurality of RF channels;
c) sending a signal to a fob using an LF channel; and
d) returning a signal to the vehicle receiver using the selected RF channel.

8. The method of claim 7, wherein said step a) includes initiating the scan by touching a door handle.

9. The method of claim 7, wherein said step a) includes initiating the scan at predetermined intervals of time.

10. The method of claim 7, wherein said step b) includes comparing the noise levels on each of the plurality of RF channels to one another.

11. The method of claim 10, wherein said step b) includes selecting the RF channel having the least amount of noise.

12. The method of claim 7, further including the step of:
setting the selected RF channel as a default transmission channel.

13. The method of claim 7, wherein said step d) includes setting an RF sender located in the fob to the selected RF channel and setting an RF receiver located in the vehicle unit to the selected RF channel.

14. A method of communication for a vehicle passive entry and start system comprising:
a) scanning a default RF channel using a vehicle receiver;
b) comparing the noise level on the default RF channels to a predetermined threshold level;
c) selecting one of a plurality of RF channels based upon said step b)
d) sending a signal to a fob using an LF channel; and
e) returning a signal to the vehicle receiver using the selected RF channel.

15. The method of claim 14, wherein said step a) includes initiating the scan by touching a door handle.

16. The method of claim 14, wherein said step a) includes initiating the scan at predetermined intervals of time.

17. The method of claim 14, wherein said step c) includes comparing the noise levels on each of the plurality of RF channels to one another.

18. The method of claim 17, wherein said step c) includes selecting the RF channel having the least amount of noise.

19. The method of claim 14, including the step of:
setting the selected RF channel as a default transmission channel.

20. The method of claim 14, wherein said step e) includes setting an RF sender located in the fob to the selected RF channel and setting an RF receiver located in the vehicle unit to the selected RF channel.
